(19) United States
(12) Patent Application Publication
(10) Pub. No.: US 2020/0148224 A1
(43) Pub. Date: May 14, 2020

(54) DRIVER ASSISTANCE APPARATUS, METHOD OF CONTROLLING THE SAME, AND DRIVER ASSISTANCE SYSTEM

(71) Applicant: MANDO CORPORATION, Pyeongtaek-si (KR)

(72) Inventor: DeokJu Kim, Seongnam-si (KR)

(21) Appl. No.: 16/677,163

(22) Filed: Nov. 7, 2019

(30) Foreign Application Priority Data
Nov. 8, 2018 (KR) 10-2018-0136466

(51) Int. Cl. B60W 50/14; B60W 50/00; G06K 9/00

(52) U.S. Cl. CPC B60W 50/14; B60W 50/0097; B60W 2050/146; G06K 9/00798; B60W 2050/143; G06K 9/00845

(57) ABSTRACT

Disclosed herein are a driver assistance apparatus for predicting a situation falling out of a system limit in advance to induce a driver to hold a steering wheel, thereby securing safety, a method of controlling the driver assistance apparatus, and a driver assistance system. The driver assistance apparatus according to an embodiment may include: a camera configured to acquire lane information of a road on which a vehicle travels, over a predetermined range; and a controller configured to receive state information of the vehicle from at least one sensor provided in the vehicle, to determine whether autonomous steering control of the vehicle is possible based on the lane information and the state information, and to control an output device provided in the vehicle to output a warning message.

### CROSS-REFERENCE TO RELATED APPLICATION

This application is based on and claims priority under 35 U.S.C. § 119 to Korean Patent Application No. 10-2018-0136466, filed on Nov. 8, 2018 in the Korean Intellectual Property Office, the disclosure of which is incorporated by reference herein in its entirety.

### BACKGROUND

### 1. Field

The present disclosure relates to a driver assistance apparatus, and more particularly, to a technique related to a driver assistance apparatus for outputting a hands-off warning for a driver upon autonomous driving.

### 2. Description of the Related Art

A hands-off warning is displayed when a driver does not hold a steering wheel for a predetermined time. A vehicle determines whether or not a driver holds a steering wheel through a torque sensor, an electrostatic sensor, an infrared sensor, etc. installed therein.

Meanwhile, when the vehicle exceeds the system limits, a lane following system among autonomous driving systems is turned off or warns a driver to guide the driver to hold the steering wheel.

A case in which it is determined that the vehicle exceeds the system limits may be a case in which it is difficult to secure the safety of autonomous driving.

However, typical technologies turn off the system after maintaining the control until a marginal situation, which fails to provide a driver with a sufficient response time so that a dangerous situation may be caused. Accordingly, system operation considering a driver's response time is required.

### SUMMARY

Therefore, it is an aspect of the present disclosure to provide a driver assistance apparatus for predicting a situation falling out of system limits in advance to induce a driver to hold a steering wheel, thereby securing safety, a method of controlling the driver assistance apparatus, and a driver assistance system.

Additional aspects of the disclosure will be set forth in part in the description which follows and, in part, will be obvious from the description, or may be learned by practice of the disclosure.

In accordance with an aspect of the present disclosure, there is provided a driver assistance apparatus including: a camera configured to acquire lane information of a road on which a vehicle travels, over a predetermined range; and a controller configured to receive state information of the vehicle from at least one sensor provided in the vehicle, to determine whether autonomous steering control of the vehicle is possible, based on the lane information and the state information, and to control an output device provided in the vehicle to output a warning message.

The controller may derive a radius of curvature of the road on which the vehicle travels, based on the lane information, and control the output device to output the warning message, when the radius of curvature is smaller than a predetermined value.

The controller may acquire driving speed of the vehicle from the at least one sensor provided in the vehicle, and calculate acceleration of the vehicle based on the driving speed of the vehicle and the radius of curvature to control the output device to output the warning message when the acceleration of the vehicle exceeds a predetermined value.

The controller may calculate a required steering torque value based on the lane information and the state information, and control the output device to output the warning message when the required steering torque value exceeds a predetermined value.

The controller may determine whether the vehicle departs from a lane, based on the lane information of the road, and control the output device to output the warning message, when the controller determines that the vehicle departs from the lane.

The controller may determine whether a driver holds a steering wheel, based on the state information, and control the output device to output the warning message based on whether the driver holds the steering wheel.

In accordance with another aspect of the present disclosure, there is provided a method of controlling a driver assistance apparatus, including: acquiring lane information of a road on which a vehicle travels, over a predetermined range; receiving state information of the vehicle based on at least one sensor provided in the vehicle; and outputting a warning message through an output device provided in the vehicle according to whether autonomous steering control of the vehicle is possible based on the lane information and the state information.

The outputting of the warning message through the output device provided in the vehicle may include: deriving a radius of curvature of the road on which the vehicle travels, based on the lane information; and controlling the output device to output the warning message, when the radius of curvature is smaller than a predetermined value.

The outputting of the warning message through the output device provided in the vehicle may include: acquiring driving speed of the vehicle from the at least one sensor provided in the vehicle, calculating acceleration of the vehicle based on the driving speed of the vehicle and the radius of curvature, and controlling the output device to output the warning message, when the acceleration of the vehicle exceeds a predetermined value.

The outputting of the warning message through the output device provided in the vehicle may include: calculating a required steering torque value based on the lane information and the state information, and controlling the output device to output the warning message, when the required steering torque value exceeds a predetermined value.

The outputting of the warning message through the output device provided in the vehicle may include: determining whether the vehicle departs from a lane, based on the lane information of the road, and controlling the output device to output the warning message when it is determined that the vehicle departs from the lane.

The outputting of the warning message through the output device provided in the vehicle may include: determining whether a driver holds a steering wheel, based on the state information; and controlling the output device to output the warning message based on whether the driver holds the steering wheel.

In accordance with another aspect of the present disclosure, there is provided a driver assistance system including: an output device; a sensor configured to acquire state information of a vehicle; a camera configured to acquire lane information of a road on which the vehicle travels, over a predetermined range; and a controller configured to receive state information of the vehicle from the sensor, to determine whether autonomous steering control of the vehicle is possible, based on the lane information and the state information, and to control the output device to output a warning message.

The controller may derive a radius of curvature of the road on which the vehicle travels, based on the lane information, and control the output device to output the warning message when the radius curvature is smaller than a predetermined value.

The controller may acquire driving speed of the vehicle from at least one sensor provided in the vehicle, calculate acceleration of the vehicle based on the driving speed of the vehicle and the radius of curvature, and control the output device to output the warning message when the acceleration exceeds a predetermined value.

The controller may calculate a required steering torque value based on the lane information and the state information, and control the output device to output the warning message when the required steering torque value exceeds a predetermined value.

The controller may determine whether the vehicle departs from a lane, based on the lane information of the road, and control the output device to output the warning message, when the controller determines that the vehicle departs from the lane.

The controller may determine whether a driver holds a steering wheel, based on the state information, and control the output device to output the warning message based on whether the driver holds the steering wheel.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows a configuration of a vehicle according to an embodiment;

FIG. 2 is a control block diagram of a driver assistance system according to an embodiment;

FIG. 3 is a view for describing operation of outputting a warning message based on a radius of curvature of a road on which a vehicle travels, according to an embodiment;

FIG. 4 is a view for describing operation of outputting a warning message based on lateral acceleration of a vehicle, according to an embodiment;

FIG. 5 is a view for describing operation of outputting a warning message based on lane departure of a vehicle, according to an embodiment;

FIG. 6 is a view for describing operation of outputting a warning message based on whether or not a driver holds a steering wheel, according to an embodiment;

FIG. 7 is a view for describing operation of outputting a warning message, according to an embodiment; and

FIG. 8 is a flowchart according to an embodiment.

### DETAILED DESCRIPTION

Like reference numerals will refer to like components throughout this specification. This specification does not describe all components of the embodiments, and general information in the technical field to which the present disclosure belongs or overlapping information between the embodiments will not be described. As used herein, the terms “portion”, “part, “module, “member” or “block” may be implemented as software or hardware, and according to embodiments, a plurality of “portions”, “parts, “modules, “members” or “blocks” may be implemented as a single component, or a single “portion”, “part, “module, “member” or “block” may include a plurality of components.

It will be understood that when a certain part is referred to as being “connected” to another part, it can be directly or indirectly connected to the other part. When a part is indirectly connected to another part, it may be connected to the other part through a wireless communication network.

Also, it will be understood that when the terms “includes,” “comprises,” “including,” and/or “comprising,” when used in this specification, specify the presence of a stated component, but do not preclude the presence or addition of one or more other components.

In the entire specification, it will also be understood that when an element is referred to as being “on” or “over” another element, it can be directly on the other element or intervening elements may also be present.

Also, the terms “first” and “second”, as applied to detectable species, are used for the purposes of identification and do not imply any order of detection.

Also, it is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

Hereinafter, an operation principle and embodiments of the present disclosure will be described with reference to the accompanying drawings.

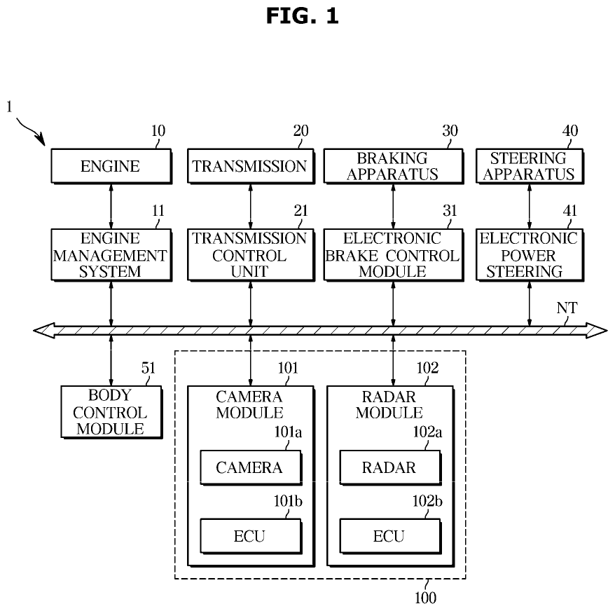

FIG. 1 shows a configuration of a vehicle according to an embodiment.

As shown in FIG. 1, a vehicle 1 may include an engine 10, a transmission 20, a braking apparatus 30, and a steering apparatus 40. The engine 10 may include a cylinder and a piston to generate power for driving the vehicle 1. The transmission 20 may include a plurality of gears, and transfer power generated by the engine 10 to a plurality of wheels. The braking apparatus 30 may rub against the wheels to reduce the speed of the vehicle 1 or to stop the vehicle 1. The steering apparatus 40 may change a driving direction of the vehicle 1.

The vehicle 1 may include a plurality of electronic components. For example, the vehicle 1 may further include an Engine Management System (EMS) 11, a Transmission Control Unit (TCU) 21, an electronic brake control module 31, an Electronic Power Steering (EPS) 41, a Body Control Module (BCM) 51, and a Driver Assistance System (DAS) 100.

The engine management system 11 may control the engine 10 in response to a driver's acceleration intention received through an accelerator pedal or a request from the driver assistance system 100. For example, the engine management system 11 may control the torque of the engine 10.

The transmission control unit 21 may control the transmission 20 in response to the driver's shift command received through a shift lever and/or driving speed of the vehicle 1. For example, the transmission control unit 21 may adjust a transmission ratio from the engine 10 to the wheels.

The electronic brake control module 31 may control the braking apparatus 30 in response to the driver's braking intention received through a brake pedal and/or the slip of the wheels. For example, the electronic brake control module 31 may temporarily release the braking of the wheels in response to the slip of the wheels sensed when the driver puts on the brakes (Anti-lock Braking Systems (ABS)). Also, the electronic brake control module 31 may selectively release the braking of the wheels in response to oversteering and/or understeering sensed upon steering of the vehicle 1 (Electronic Stability Control (ESC)). Also, the electronic brake control module 31 may temporarily brake the wheels in response to the slip of the wheels sensed when the vehicle 1 is driven (Traction Control System (TCS)).

The electronic steering apparatus 41 may assist operation of the steering apparatus 40 to enable the driver to easily operate the steering wheel in response to the drivers steering intention received through the steering wheel. For example, the electronic steering apparatus 41 may assist operation of the steering apparatus 40 to decrease a steering force upon low-speed driving or parking and to increase the steering force upon high-speed driving.

The body control module 51 may control operations of electronic components for providing the driver with convenience or securing the driver's safety. For example, the body control module 51 may control a headlamp, wipers, a cluster, a multi-functional switch, turn signals, etc.

The driver assistance system 100 may assist the driver to operate (drive, brake, and steer) the vehicle 1. For example, the driver assistance system 100 may sense surroundings (for example, another vehicle, a pedestrian, a cyclist, a lane, a road sign, etc.) of the vehicle 1, and control driving and/or braking and/or steering of the vehicle 1 according to the sensed surroundings.

The driver assistance system 100 may provide the driver with various functions. For example, the driver assistance system 100 may provide the driver with Lane Departure Warning (LDW), Lane Keeping Assist (LKA), High Beam Assist (HBA), Autonomous Emergency Braking (AEB), Traffic Sign Recognition (TSR), Smart Cruise Control (SCC), Blind Spot Detection (BSD), etc.

The driver assistance system 100 may include a camera module 101 for acquiring image data about surroundings of the vehicle 1, and a radar module 102 for acquiring object data about the surroundings of the vehicle 1.

The camera module 101 may include a camera 101a and an Electronic Control Unit (ECU) 101b, and photograph a front view of the vehicle 1 to recognize another vehicle, a pedestrian, a cyclist, a lane, a road sign, etc.

The radar module 102 may include a radar 102a and a controller 102b, and acquire a relative position and relative speed of an object (for example, another vehicle, a pedestrian, a cyclist, etc.) around the vehicle 1.

The above-described electronic components may communicate with each other through a vehicle communication network NT. For example, the electronic components may transmit/receive data to/from each other through the Ethernet, Media Oriented Systems Transport (MOST), FlexRay, a Controller Area Network (CAN), a Local Interconnect Network (LIN), and the like. For example, the driver assistance system 100 may transmit a driving control signal, a braking signal, and a steering signal to the engine management system 11, the electronic brake control module 31, and the electronic steering apparatus 41, respectively, through the vehicle communication network NT.

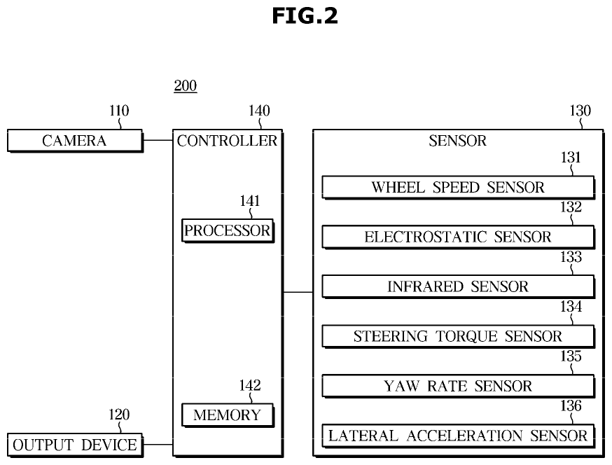

FIG. 2 is a control block diagram of a driver assistance system according to an embodiment.

As shown in FIG. 2, the driver assistance system may include a camera 110, an output device 120, a controller 140, and a sensor 130.

The camera 110 may acquire lane information of a road on which the vehicle 1 travels, over a predetermined range.

The predetermined range may be a view range of the camera 110. According to an embodiment, the view range of the camera 110 may be set to 2 seconds (T.B.D).

The camera 110 may have a field of view 110a toward a front direction from the vehicle 1. The camera 110 may be installed, for example, in a front wind shield of the vehicle 1. The camera 110 may photograph a front view of the vehicle 1 to acquire image data about the front view of the vehicle 1. The image data about the front view of the vehicle 1 may include position information about another vehicle, a pedestrian, a cyclist, or a lane located in the front direction from the vehicle 1.

The camera 110 may include a plurality of lenses and an image sensor. The image sensor may include a plurality of photodiodes for converting light to an electrical signal, wherein the plurality of photodiodes may be arranged in a 2Dimensional (2D) matrix form. The camera 110 may be electrically connected to the controller 140. For example, the camera 110 may be connected to the controller 140 through the vehicle communication network NT, a hard wire, or a Printed Circuit Board (PCB). The camera 110 may transfer the image data about the front view of the vehicle 1 to the controller 140. The sensor 130 may include at least one sensor, and according to an embodiment, the sensor 130 may include a wheel speed sensor 131, an electrostatic sensor 132, an infrared sensor 133, a steering torque sensor 134, a yaw rate sensor 135 and a lateral acceleration sensor 136.

The wheel speed sensor 131 may be installed in each of the four front and rear wheels to sense the rpms of the respective wheels based on changes in lines of magnetic force in the sensors and a tone wheel, and to transfer the rpms of the wheels to a computer. The controller 140 may derive a driving distance for each driving situation which will be described later, based on the rpms of the wheels acquired by the wheel speed sensor 131. More specifically, the controller 140 may derive a driving state of the vehicle 1, based on a driving distance per unit time measured by the wheel speed sensor 131, which will be described later. Also, the wheel speed sensor 131 may measure the rpms of the wheels, and the controller 140 may calculate differences in rpm between the four wheels to determine whether the road is slippery. The electrostatic sensor 132, the infrared sensor 133 and a steering torque sensor 134 may be installed in the inside of the vehicle 1 to acquire vehicle state information based on which whether or not the driver holds the steering wheel is determined.

The output device 120 may output a warning message based on operation of the controller 140.

The warning message may be output in any form as it can guide the driver to hold the steering wheel.

The output device 120 may be configured with a display or a speaker.

The display may be a Cathode Ray Tube (CRT), a Digital Light Processing (DLP) panel, a Plasma Display Panel (PDP), a Light Crystal Display (LCD) panel, an Electro Luminescence (EL) panel, an Electrophoretic Display (EPD) panel, an Electrochromic Display (ECD) panel, a Light Emitting Diode (LED) panel, or an Organic Light Emitting Diode (OLED) panel, although not limited to these.

The speaker may output sound required for performing an audio function, a video function, a navigation function, and other additional functions. The speaker may output a warning message in the form of a sound signal.

The controller 140 may include the controller 101b (see FIG. 1) of the camera module 101 (see FIG. 1) and/or the controller 102b (see FIG. 1) of the radar module 102 and/or a separate integrated controller.

The controller 140 may receive state information of the vehicle 1 from at least one sensor installed in the vehicle 1. The state information of the vehicle 1 may include information based on which whether the driver holds the steering wheel is determined, the information including the speed of the vehicle 1.

The controller 140 may determine whether autonomous steering control of the vehicle 1 is possible, based on the state information and lane information acquired from the camera 110. Whether autonomous steering control is possible may be determined based on a curvature of a road on which the vehicle 1 travels, acceleration of the vehicle 1, etc., which will be described later.

The controller 140 may control the output device 120 installed in the vehicle 1 to output a warning message.

The controller 140 may derive a radius of curvature of the road on which the vehicle 1 travels, based on the lane information.

When the controller 140 determines that the radius of curvature is smaller than a predetermined value, the controller 140 may control the output device 120 to output the warning message. The controller 140 may determine the case in which the radius of curvature is smaller than the predetermined value, as a case in which performing autonomous steering control is inappropriate since a curvature of the road is great.

The controller 140 may acquire driving speed of the vehicle 1 from at least one sensor installed in the vehicle 1. The controller 140 may acquire driving speed of the vehicle 1 from the wheel speed sensor 131, as described above.

The controller 140 may calculate acceleration of the vehicle 1 based on the driving speed of the vehicle 1 and the radius of curvature, and when the controller 140 determines that the acceleration exceeds a predetermined value, the controller 140 may control the output device 120 to output the warning message. Details about operation in which the controller 140 calculates acceleration of the vehicle 1 and compares the acceleration with the predetermined value will be described later.

The controller 140 may calculate a required steering torque value based on the lane information and the state information.

When the controller 140 determines that the required steering torque value exceeds a predetermined value, the controller 140 may control the output device 120 to output the warning message. The controller 140 may determine the case in which the required steering torque value exceeds the predetermined value, as a case in which autonomous steering control is inappropriate since a curvature of a road on which the vehicle travels is great.

The controller 140 may determine whether the vehicle 1 departs from a lane, based on the lane information of the road, and when the controller 140 determines that the vehicle 1 departs from the lane, the controller 140 may control the output device 120 to output the warning message.

The controller 140 may determine whether or not the driver holds the steering wheel, based on the state information. As described above, the state information may include information acquired by the electrostatic sensor and the infrared sensor.

The controller 140 may control the output device 120 to output the warning message, based on whether or not the driver holds the steering wheel.

When the controller 140 determines that the driver holds the steering wheel, the controller 140 may determine that the driver has a control authority, and may output no warning message.

The controller 140 may include a processor 141 and a memory 142.

The processor 141 may process front-view image data acquired by the camera 110, and generate a braking signal and a steering signal for controlling the steering apparatus 40. For example, the processor 141 may include an image signal processor for processing front view data of the camera 110 and/or a Micro Control Unit (MCU) for generating a brake signal and a steering signal.

The processor 141 may sense front objects (for example, another vehicle, a pedestrian, a cyclist, etc.) existing in the front direction from the vehicle 1, based on the front-view image data of the camera 110.

The processor 141 may generate a braking signal and a steering signal based on type information, location information, and speed information of the front objects.

For example, the processor 141 may calculate a Time to Collision (TTC) between the vehicle 1 and the front objects based on the location information (a distance) and the speed information (relative speed) of the front objects, and warn a driver of a collision or transmit a brake signal to the braking apparatus 30 based on the result of comparison between the TTC and a predetermined reference time. The memory 142 may store a program and/or data required by the processor 141 to process image data, and a program and/or data required by the processor 141 to generate a steering signal.

The memory 142 may temporarily store image data received from the camera 110, and temporarily store image data of the processor 141. The memory 142 may include volatile memory, such as a flash memory, Read Only Memory (ROM), Erasable Programmable Read Only Memory (EPROM), etc., as well as volatile memory, such as S-RAM and D-RAM. Meanwhile, the embodiments may be implemented in the form of a recording medium storing instructions executable by a computer. The instructions may be stored in the form of a program code, and when executed by a processor, the instructions may generate a program module to perform the operations of the disclosed embodiments. The recording medium may be implemented as a computer-readable recording medium.

The computer-readable recording medium may include all kinds of recording media storing instructions that can be interpreted by a computer. For example, the computer-readable recording medium may include ROM, Random Access Memory (RAM), a magnetic tape, a magnetic disc, flash memory, an optical data storage device, etc.

So far, the disclosed embodiments have been described with reference to the accompanying drawings. It will be apparent that those skilled in the art can make various modifications thereto without changing the technical spirit and essential features of the present disclosure. Thus, it should be understood that the embodiments described above are merely for illustrative purposes and not for limitation purposes in all aspects.

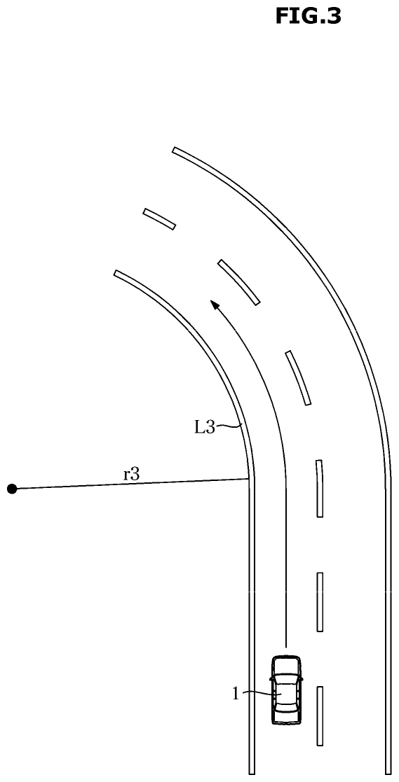

FIG. 3 is a view for describing operation of outputting a warning message based on a radius of curvature of a road on which a vehicle travels, according to an embodiment.

Referring to FIG. 3, when the vehicle 1 travels on a road, the vehicle 1 may acquire lane information of the road on which it travels, based on a lane L3. The vehicle 1 may calculate a radius r3 of curvature of the road on which the vehicle 1 travels, based on the acquired lane information.

Meanwhile, when acquiring information about the road on which the vehicle 1 travels, the vehicle 1 may acquire information over a predetermined range. The predetermined range may be a view range of the camera 110, as described above. According to an embodiment, the view range of the camera 110 may be set to 2 seconds (T.B.D). Since the vehicle 1 predicts driving over a wide view range, the vehicle 1 may output a warning message in advance, and secure the driver's response time.

Meanwhile, when the acquired radius r3 of curvature is smaller than a predetermined value, the vehicle 1 may determine that autonomous steering control is inappropriate since a curvature of the road is great. In this case, the vehicle 1 may output a warning message on the output device 120.

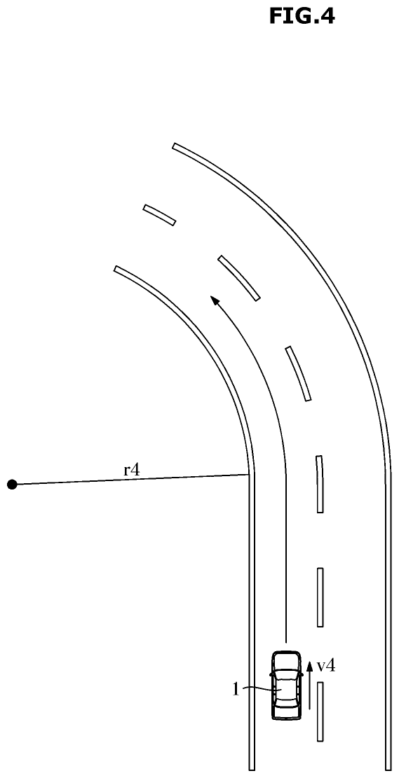

FIG. 4 is a view for describing operation of outputting a warning message based on lateral acceleration of a vehicle, according to an embodiment.

Referring to FIG. 4, when the vehicle 1 travels on a road, the vehicle 1 may acquire lane information of the road on which it travels, based on a lane L4. The vehicle 1 may calculate a radius r4 of curvature of the road on which it travels, based on the lane information.

Meanwhile, as described above, the controller 140 may acquire state information of the vehicle 1 through a sensor installed in the vehicle. The state information of the vehicle 1 may include speed information v4 detected by a wheel speed sensor installed in the vehicle 1. Meanwhile, the controller 140 may calculate lateral acceleration of the vehicle 1 using the radius r4 of curvature of the road on which the vehicle 1 travels and the speed of the vehicle 1. The wheel speed of the vehicle 1 may be derived according to Equation (1), below.

$$a 4 ( m \text{/} {s}^{2} ) = \frac{{( v 4 )}^{2}}{r 4} \qquad ( 1 )$$

In Equation (1), a4 represents lateral acceleration of the vehicle 1, v4 represents speed of the vehicle 1, and r4 represents a radius of curvature.

Meanwhile, the controller 140 may compare the lateral acceleration derived based on the above-described operation with a predetermined value, and when the lateral acceleration exceeds the predetermined value, the controller 140 may determine that autonomous steering control is inappropriate, and output a warning message on the output device 120.

Meanwhile, the controller 140 may calculate a required steering torque value required for the vehicle 1 to travel safely, based on the lateral acceleration. When the required steering torque value exceeds a predetermined value, the controller 140 may determine that autonomous steering control is inappropriate, and output a warning message on the output device 120. Meanwhile, operation of calculating a required steering torque value based on lateral acceleration has been well known in the art, and accordingly, detailed descriptions thereof will be omitted.

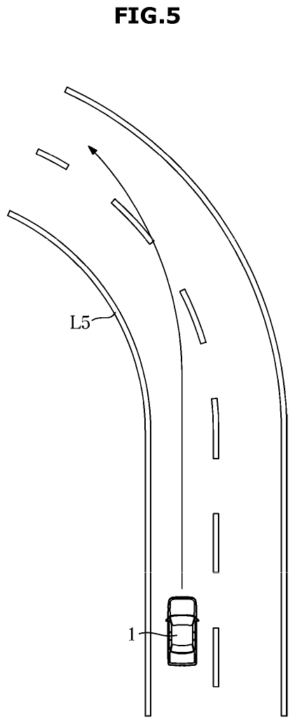

FIG. 5 is a view for describing operation of outputting a warning message based on lane departure of a vehicle, according to an embodiment.

Referring to FIG. 4, the vehicle 1 may acquire lane information L5 of a road on which it travels, through the camera 110, etc. installed thereon. Since the controller 140 can derive location information of the lane based on the lane information L5, the controller 140 may determine whether the vehicle 1 departs from the lane. When the vehicle 1 departs from the lane, there is high probability that safety of autonomous steering control will be not secured. Therefore, in this case, the controller 140 may control the output device 120 to output a warning message.

Also, as described above, the controller 140 may derive lateral acceleration of the vehicle 1, and when the controller 140 determines that the lateral acceleration exceeds a predetermined value, the controller 140 may determine that the vehicle 1 departs from the lane, and control the output device 120 to output a warning message.

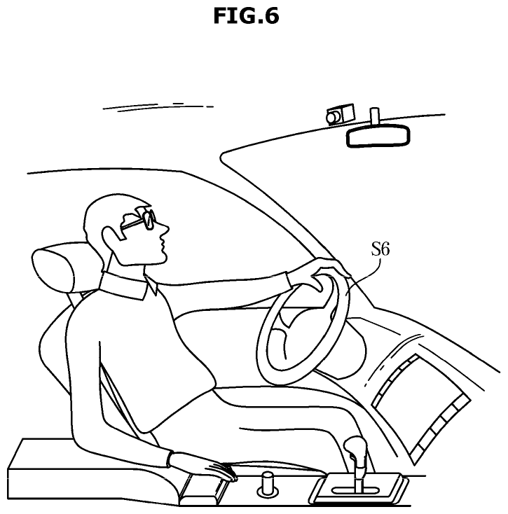

FIG. 6 is a view for describing operation of outputting a warning message based on whether or not a driver holds a steering wheel S6, according to an embodiment.

Referring to FIG. 6, a driver may hold the steering wheel S6 under autonomous steering control. When the driver holds the steering wheel S6, a static sensor installed in the steering wheel S6 may acquire a signal informing that a driver holds the steering wheel S6.

According to an embodiment, when a driver holds the steering wheel S6, the static sensor may detect a change in capacitance, and transfer the change in capacitance to the controller 140. When the controller 140 determines that a driver holds the steering wheel S6, the controller 140 may output no warning message even when autonomous steering control is impossible, since the driver has a control authority.

In contrast, when the driver does not hold the steering wheel S6, the static sensor may detect no change in capacitance, and the controller 140 may determine that the driver does not hold the steering wheel S6. In this case, since the driver has no control authority, the controller 140 may output a warning message when autonomous steering control is impossible.

Meanwhile, the operations described above with reference to FIGS. 4 to 6 are embodiments of the present disclosure, and operations of outputting a warning message when autonomous steering control is impossible are not limited to the embodiments.

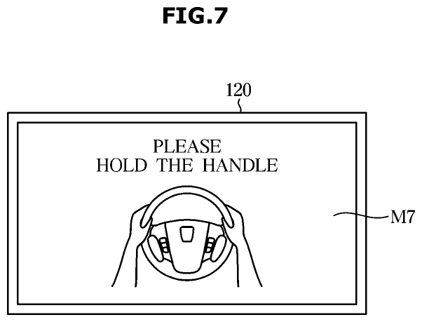

FIG. 7 is a view for describing operation of outputting a warning message, according to an embodiment.

When the controller 140 determines that autonomous steering control is impossible and that a driver does not hold the steering wheel S6, the controller 140 may output a warning message, as shown in FIG. 7.

FIG. 7 shows a warning message M7 output on the output device 120 provided in the vehicle 1. According to an embodiment, the controller 140 may output a character string M7, such as “Please hold the handle”, on a navigation display.

Meanwhile, the controller 140 may output a warning message on a cluster provided in the vehicle, instead of the navigation display.

Also, the controller 140 may output a warning message aurally through a speaker provided in the vehicle 1.

Meanwhile, operation of outputting a warning message is not limited as long as the controller 140 outputs a warning message through the output device 120 to warn a user.

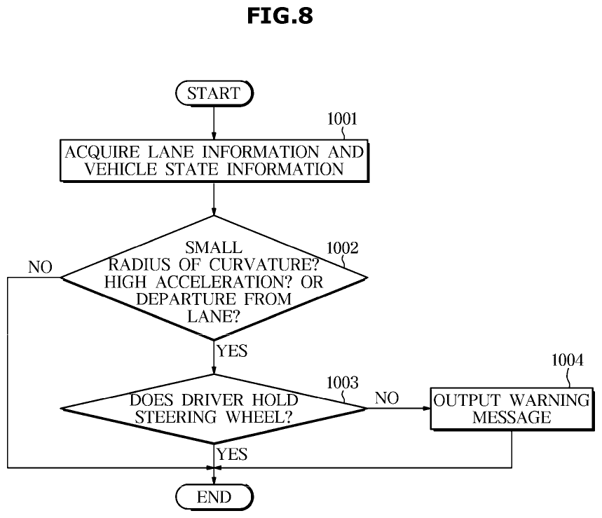

FIG. 8 is a flowchart according to an embodiment.

Referring to FIG. 8, the controller 140 may acquire lane information and vehicle state information, in operation 1001. When a radius of curvature of a road on which the vehicle 1 travels is smaller than a predetermined value, when lateral acceleration of the vehicle 1 exceeds a predetermined value, or when the vehicle 1 departs from a lane, the controller 140 may determine that automatic steering control is impossible, in operation 1002.

In this case, the controller 140 may determine whether a driver holds a steering wheel, in operation 1003, and when the controller 140 determines that the driver does not hold the steering wheel, the controller 140 may output a warning message on the output device 120, in operation 1004.

As described above, the method of controlling the driver assistance apparatus and the driver assistance system, according to the current embodiments, may predict a situation falling out of system limits in advance to induce a driver to hold the steering wheel, thereby securing safety.

Meanwhile, the disclosed embodiments may be implemented in the form of a recording medium storing instructions executable by a computer. The instructions may be stored in the form of a program code, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be ROM, RAM, a magnetic tape, a magnetic disc, a flash memory, an optical data storage device, etc.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A driver assistance apparatus comprising:
a camera configured to acquire lane information of a road on which a vehicle travels, over a predetermined range; and
a controller configured to receive state information of the vehicle from at least one sensor provided in the vehicle,
to determine whether autonomous steering control of the vehicle is possible, based on the lane information and the state information, and
to control an output device provided in the vehicle to output a warning message.

2. The driver assistance apparatus according to claim 1, wherein the controller derives a radius of curvature of the road on which the vehicle travels, based on the lane information, and
controls the output device to output the warning message, when the radius of curvature is smaller than a predetermined value.

3. The driver assistance apparatus according to claim 2, wherein the controller acquires driving speed of the vehicle from the at least one sensor provided in the vehicle, and
calculates acceleration of the vehicle based on the driving speed of the vehicle and the radius of curvature to control the output device to output the warning message when the acceleration of the vehicle exceeds a predetermined value.

4. The driver assistance apparatus according to claim 1, wherein the controller calculates a required steering torque value based on the lane information and the state information, and
controls the output device to output the warning message when the required steering torque value exceeds a predetermined value.

5. The driver assistance apparatus according to claim 1, wherein the controller determines whether the vehicle departs from a lane, based on the lane information of the road, and
controls the output device to output the warning message when the controller determines that the vehicle departs from the lane.

6. The driver assistance apparatus according to claim 1, wherein the controller determines whether a driver holds a steering wheel, based on the state information, and
controls the output device to output the warning message based on whether the driver holds the steering wheel.

7. A method of controlling a driver assistance apparatus, comprising:
acquiring lane information of a road on which a vehicle travels, over a predetermined range;
receiving state information of the vehicle based on at least one sensor provided in the vehicle; and
outputting a warning message through an output device provided in the vehicle according to whether autonomous steering control of the vehicle is possible based on the lane information and the state information.

8. The method according to claim 7, wherein the outputting of the warning message through the output device provided in the vehicle comprises:
deriving a radius of curvature of the road on which the vehicle travels, based on the lane information; and
controlling the output device to output the warning message when the radius of curvature is smaller than a predetermined value.

9. The method according to claim 8, wherein the outputting of the warning message through the output device provided in the vehicle comprises:
acquiring driving speed of the vehicle from the at least one sensor provided in the vehicle, and
calculating acceleration of the vehicle based on the driving speed of the vehicle and the radius of curvature to control the output device to output the warning message when the acceleration of the vehicle exceeds a predetermined value.

10. The method according to claim 7, wherein the outputting of the warning message through the output device provided in the vehicle comprises:
calculating a required steering torque value based on the lane information and the state information, and
controlling the output device to output the warning message when the required steering torque value exceeds a predetermined value.

11. The method according to claim 7, wherein the outputting of the warning message through the output device provided in the vehicle comprises:
determining whether the vehicle departs from a lane, based on the lane information of the road, and
controlling the output device to output the warning message when it is determined that the vehicle departs from the lane.

12. The method according to claim 7, wherein the outputting of the warning message through the output device provided in the vehicle comprises:
determining whether a driver holds a steering wheel, based on the state information; and
controlling the output device to output the warning message based on whether the driver holds the steering wheel.

13. A driver assistance system comprising:
an output device;
a sensor configured to acquire state information of a vehicle;
a camera configured to acquire lane information of a road on which the vehicle travels, over a predetermined range; and
a controller configured to receive state information of the vehicle from the sensor,
to determine whether autonomous steering control of the vehicle is possible, based on the lane information and the state information, and
to control the output device to output a warning message.

14. The driver assistance system according to claim 13, wherein the controller derives a radius of curvature of the road on which the vehicle travels, based on the lane information, and
controls the output device to output the warning message, when the radius of curvature is smaller than a predetermined value.

15. The driver assistance system according to claim 13, wherein the controller acquires driving speed of the vehicle from at least one sensor provided in the vehicle, and
calculates acceleration of the vehicle based on the driving speed of the vehicle and the radius of curvature to control the output device to output the warning message when the acceleration exceeds a predetermined value.

16. The driver assistance system according to claim 13, wherein the controller calculates a required steering torque value based on the lane information and the state information, and
controls the output device to output the warning message when the required steering torque value exceeds a predetermined value.

17. The driver assistance system according to claim 13, wherein the controller determines whether the vehicle departs from a lane, based on the lane information of the road, and
controls the output device to output the warning message when the controller determines that the vehicle departs from the lane.

18. The driver assistance system according to claim 13, wherein the controller determines whether a driver holds a steering wheel, based on the state information, and
controls the output device to output the warning message based on whether the driver holds the steering wheel.
